(19) United States
(12) Patent Application Publication
(10) Pub. No.: US 2023/0193827 A1
(43) Pub. Date: Jun. 22, 2023

(54) FAN CASE ASSEMBLY FOR A GAS TURBINE ENGINE

(71) Applicant: ROLLS-ROYCE DEUTSCHLAND LTD & CO KG, Blankenfelde-Mahlow (DE)

(72) Inventors: Robert W. HEETER, Noblesville, IN (US); Grace BARNES, Indianapolis, IN (US); Jonathan M. RIVERS, Indianapolis, IN (US)

(21) Appl. No.: 17/721,764

(22) Filed: Apr. 15, 2022

Related U.S. Application Data
(60) Provisional application No. 63/292,082, filed on Dec. 21, 2021.

(51) Int. Cl. F02C 7/24; F01D 11/12

(52) U.S. Cl. CPC F02C 7/24; F01D 11/122; F05D 2220/323; F05D 2240/14; F05D 2240/55; F05D 2260/96

(57) ABSTRACT

Aspects of the disclosure regard a fan case assembly for a gas turbine engine, the fan case assembly comprising a fan case having an inner surface, a fan track liner comprising abradable material layer, and a rear acoustic panel arranged aft of the fan track liner. The fan track liner and the rear acoustic panel are integrated into a single panel structure attached to the fan case inner surface.

This application claims priority to U.S. Provisional Patent Application 63/292,082 filed Dec. 21, 2021, the entirety of which is incorporated by reference herein.

The present disclosure relates to a fan case assembly for a gas turbine engine.

Turbofan gas turbine engines comprise a generally cylindrical fan case which encloses a fan driven by a core engine of the gas turbine engine. The fan case's primary function is to provide the aeroline and to contain a released airfoil if one were to become liberated from the rotor, but its linings do also serve other functions such as attenuating noise and providing an abradable surface that can manage tip rubs during maneuvers, bird strikes, and the like. To maintain operation without costly repair and overhauls, the inner surface should be robust to impacts and wear. Additionally, it is helpful to be able to exchange panels on-wing if one were to become damaged, and bolting the liners enables this.

It is known to provide a fan case with fan case liners. Within a limited axial extent, fan case liners must provide an abradable surface for the fan rotor as well as survive ice shed from the fan rotor blades, and also attenuate noise and improve flutter margin with acoustic treatment. In traditional configurations, as fan case liners are provided a fan track liner and a rear acoustic panel located aft of the fan track liner. An ice impact liner may be arranged between the fan track liner and the rear acoustic panel. The fan track liner comprises an abradable surface adjacent the rotor blades. The rear acoustic panel provides perforated skins and honeycomb for noise treatment. Multiple rows of bolting are used to connect the fan case liners with the fan case.

There is a desire to further improve fan case assemblies with fan case liners.

According to an aspect of the invention, a fan case assembly for a gas turbine engine is provided. The fan case assembly comprises a fan case having an inner surface, a fan track liner comprising an abradable material layer, and a rear acoustic panel arranged aft of the fan track liner. It is provided that the fan track liner and the rear acoustic panel are integrated into a single panel structure attached to the fan case inner surface. In embodiments, an ice impact liner is additionally integrated into the single panel structure.

Aspects of the invention are thus based on the idea to combine at least a fan track liner and a rear acoustic panel into one component. Rather than implementing the fan track liner and the rear acoustic panel as individual parts individually connected to the fan case utilizing multiple rows of fasteners close to each other, a single panel structure is provided. This is associated with the advantage of reduced engine weight because of reduced rows of fasteners. Also, by reducing the fastener area, a zone for new functionality is added which may be used to maximize the effective treated area for noise benefit.

Further advantages are associated with such concept. By reducing the fastener area, the assembly time is speed up. Further, filler material between adjacent panels is avoided as well as any foam strips and the like. Less holes in the fan case is also better for fire and vent protection. Costs savings can be achieved due to the reduction in fasteners and redundant features or interfaces.

In an embodiment, the single panel structure comprises an outer tray extending between a front end and an aft end of the single panel structure, wherein the outer tray forms an outer structure of the single panel structure holding the fan track liner and the rear acoustic panel, wherein the outer tray is connected to the fan case. Accordingly, an outer tray is provided which is connected to the fan case and which is configured to receive and hold the fan track liner and the rear acoustic panel. If an ice impact panel is implemented, the outer tray is configured to also receive and hold the ice impact panel. The outer tray may be tray formed by carbon fiber composite material which provides for weight and stiffness benefits.

In an embodiment, the outer tray is connected at three axial positions only to the fan case to minimize the required rows of fasteners and thus reduce the area covered by fasteners which do not count as effective noise treatment area. For example, the outer tray is connected to the fan case at a front end, at an aft end, and at a middle position.

Generally, the mechanical connection between the outer tray and the fan case may be implemented in a plurality of manners as known to the person skilled in the art. Embodiments of the connection include fasteners formed by screws, bolts or flange connections.

In a further embodiment, the fan track liner and the rear acoustic panel are formed by two different compartments of the single panel structure, wherein each compartment is held by the outer tray. Accordingly, different compartments or sub-structures are provided in the single panel structure which allows it to provide different functionalities within the single panel structure.

More particularly, in an embodiment, the fan track liner compartment and the rear acoustic panel compartment each comprise a honeycomb core structure, wherein the honeycomb core structures of the fan track liner compartment and the rear acoustic panel compartment differ in at least one of cell configuration, cell size and density. For example, the honeycomb core structure of the fan track liner compartment may comprise a Flex-Core cell configuration, wherein the honeycomb core structure of the rear acoustic panel compartment may comprise a hexagonal cell configuration. In another example, the honeycomb core structures may differ in cell size and thus cell number.

In still another example, the honeycomb core structure of the fan track liner compartment may have a higher density than the honeycomb core structure of the rear acoustic panel compartment, wherein the density may be measured as pounds per cubic foot (pcf). For example, the density of the honeycomb core structure of the fan track liner compartment may be in the range between 5 and 6 pcf, and the density of the honeycomb core structure of the rear acoustic panel compartment may be in the range between 3.5 and 4.5 pcf.

The provision of compartments in the single panel structure also allows to tailor the inner skin or face sheet in accordance with the required function of the respective compartment. In an embodiment, the honeycomb core structure of the fan track liner compartment is covered by a composite septum sheet to which a layer of abradable material is attached. The provision of a layer of abradable material is essential for the fan track liner. During operation of the engine, the fan blades rotate freely within the fan track liner. At their maximum extension of movement the blades cut a path into the abradable layer creating a seal against the fan casing and minimizing air leakage around the blade tips.

The other hand, the honeycomb core structure of the rear acoustic panel may be covered by a perforated inner face sheet. The perforated area can be particularly large in view of the reduction of fasteners and the increase in effective acoustic area as associated with aspects of the present invention. This permits not only effective noise reduction, but also provides flutter margin to the rotor. When using a Fan Blisk, this is of particular interest due to the lack of mechanical damping inherent with a Fan Blisk.

In another embodiment, an inner skin of the rear acoustic panel compartment and the aft end of the outer tray form an aft flange which is connected to the fan case. In this embodiment, the aft flange bonds the outer tray and the inner skin together. This provides for improved integrity and strength.

In an alternative embodiment, an inner skin of the rear acoustic panel compartment and the aft end of the outer tray are connected to the fan case by means of a through fastener, wherein the structure of the rear acoustic panel is reinforced in the area of the through fastener.

In a further embodiment, an inner skin of the rear acoustic panel compartment forms a radial offset that is radially trapped with a retention ring that is bolted to the structure of the fan case. The radial trapping provides for a radial fixation of the single panel structure at its aft end. Axial fixation may be provided by front and middle fastening means.

In a further embodiment, as mentioned before, the single panel further comprises an ice impact liner compartment arranged between the fan track liner compartment and the rear acoustic panel compartment. It may be provided that the ice impact liner compartment comprises a honeycomb core structure different from the honeycomb core structures of the fan track liner compartment and the rear acoustic panel compartment. Accordingly, in this embodiment, different honeycomb structures are implemented with the fan track liner compartment, the ice impact panel compartment and the rear acoustic panel compartment.

An added benefit of this embodiment is that the ice impact panel may be reinforced with newer materials and used to acoustically treat as well. This may enable greater rotor performance by reducing concern around flutter margin so that the design could be more aggressive. In particular, it may be provided in embodiments that the ice impact portion of the single panel is also perforated to provide the benefit of flutter mitigation. Although a thick laminate is not preferred for acoustic attenuation, it may still aid the fan's operability margin by acting as a deep flutter liner. This is a particular aspect for fan blisks which lack the inherent mechanical damping of a bladed wheel.

In an embodiment, the ice impact liner compartment comprises a non-perforated inner face sheet formed by a laminate material comprised of a plurality of plies. Such plies may include glass fiber composite plies and high modulus polypropylene fiber composite plies. Such a laminate comprises improved impact strength. However, in other embodiments, as mentioned above, the face sheet of the ice impact liner compartment may be perforated.

In an embodiment, the single panel structure comprises an inner skin delimiting the outer flow path through the fan, wherein the inner skin comprises at least in sections a layer made of high modulus polypropylene fibers or hybrid fibers containing high modulus polypropylene. High modulus polypropylene (such as Innegra) is a high performance fiber which improves impact resistance. Different sections of the inner skin of the single panel structure may be formed by different materials and/or may be structured differently in accordance with the required functionality as discussed.

In an embodiment, at least the rear acoustic panel compartment of the single panel structure in cross section converges along its full length in the aft direction. Such profile allows to replace the single panel structure on-wing if damaged by moving it in/against the axial direction (when the fan is dismantled).

In a further embodiment, the fan case comprises a converging profile along the axial length of the single panel structure, in particular between front fasteners of the single panel structure and outlet guide vanes. This is particularly helpful for providing a single piece outer tray which forms a straight section along most of its length. Also, this further allows to replace the single panel structure on-wing if damaged by moving it in/against the axial direction (when the fan is dismantled).

It is pointed out that the single panel structure which at least integrates the fan track liner and the rear acoustic panel may extend not over 360° in the circumferential direction but may be formed of elements or panels which extend over less 360° degrees in the circumferential direction. For example, the single panel structure may be formed by five, seven, nine, eleven or thirteen identical panels each extending in the same manner in the axial direction and which are arranged next to each other in the circumferential direction.

In a further aspect of the invention a gas turbine engine for an aircraft is provided which comprises:

an engine core comprising a turbine, a compressor, and a core shaft connecting the turbine to the compressor;

a fan located upstream of the engine core, the fan comprising a plurality of fan blades;

a planetary gearbox that receives an input from the core shaft and outputs drive to the fan so as to drive the fan at a lower rotational speed than the core shaft; and

a fan case assembly in accordance with claim 1, wherein the fan is enclosed by the fan case assembly.

In an embodiment, it is provided that

the turbine is a first turbine, the compressor is a first compressor, and the core shaft is a first core shaft;

the engine core further comprises a second turbine, a second compressor, and a second core shaft connecting the second turbine to the second compressor; and

the second turbine, second compressor, and second core shaft are arranged to rotate at a higher rotational speed than the first core shaft.

It should be noted that the present invention is described in terms of a cylindrical coordinate system having the coordinates x, r and φ. Here x indicates the axial direction, r the radial direction and φ the angle in the circumferential direction. The axial direction is defined by the machine axis of the gas turbine engine in which the present invention is implemented, with the axial direction pointing from the engine inlet to the engine outlet. Starting from the x-axis, the radial direction points radially outwards. Terms such as “in front of”, “forward”, “behind”, “rearward” and “aft” refer to the axial direction or flow direction in the engine. Terms such as “outer” or “inner” refer to the radial direction.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Utip. The work done by the fan blades 13 on the flow results in an enthalpy rise dH of the flow. A fan tip loading may be defined as dH/Utip2, where dH is the enthalpy rise (for example the 1-D average enthalpy rise) across the fan and Utip is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg-1K-1/(ms-1)2). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg-1s, 105 Nkg-1s, 100 Nkg-1s, 95 Nkg-1s, 90 Nkg-1s, 85 Nkg-1s or 80 Nkg-1s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example, at least a part of the fan blade and/or aerofoil may be manufactured at least in part from a composite, for example a metal matrix composite and/or an organic matrix composite, such as carbon fiber. By way of further example at least a part of the fan blade and/or aerofoil may be manufactured at least in part from a metal, such as a titanium based metal or an aluminum based material (such as an aluminum-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fiber or aluminum based body (such as an aluminum lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a blisk or a bling. Any suitable method may be used to manufacture such a blisk or bling. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

The invention will be explained in more detail on the basis of exemplary embodiments with reference to the accompanying drawings in which:

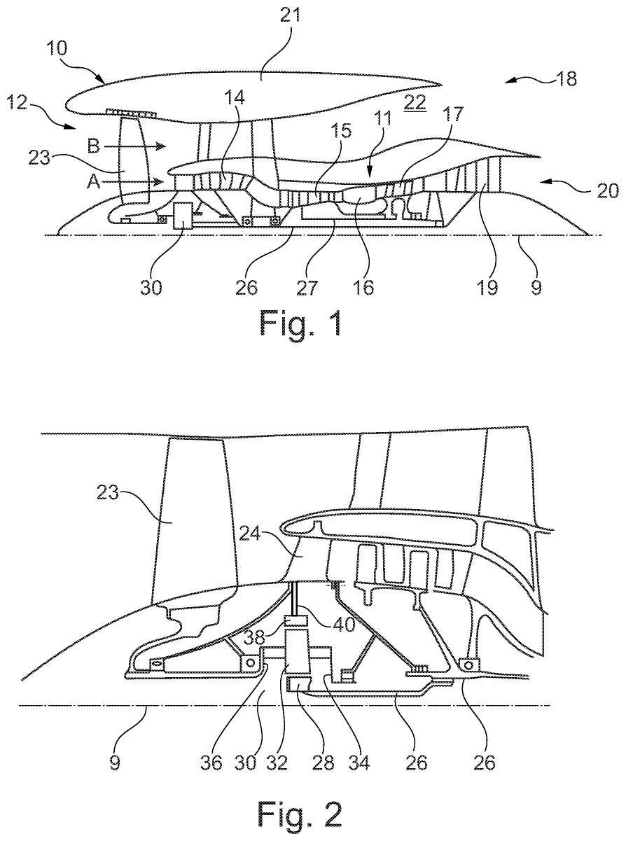

FIG. 1 is a sectional side view of a gas turbine engine;

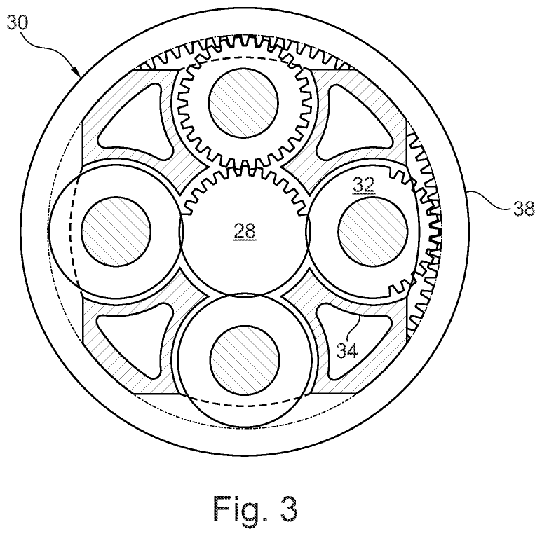

FIG. 2 is a close up sectional side view of an upstream portion of a gas turbine engine;

FIG. 3 is a partially cut-away view of a gearbox for a gas turbine engine;

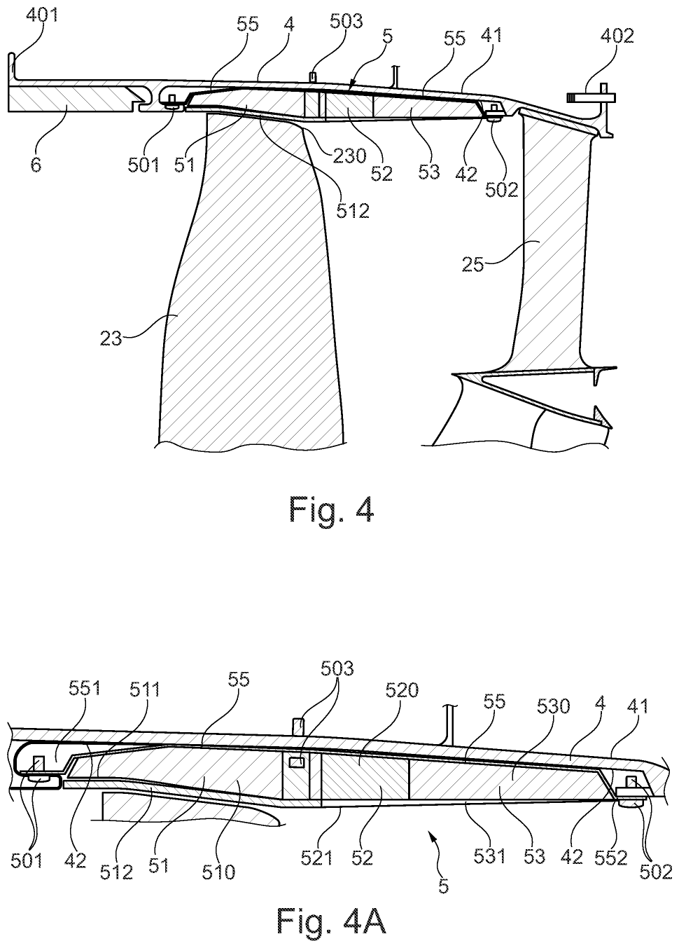

FIG. 4 is an embodiment of a fan case assembly comprising a fan track liner and a rear acoustic panel integrated into a single panel structure, wherein the aft end of the single panel structure forms an aft flange;

FIG. 4A an enlarged view of the single panel structure of the fan case assembly of FIG. 4;

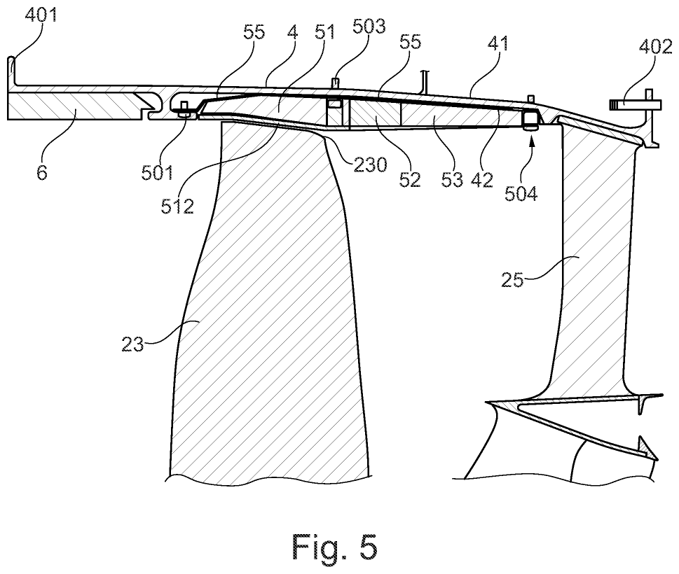

FIG. 5 is a further embodiment of a fan case assembly comprising a fan track liner and a rear acoustic panel integrated into a single panel structure, wherein the aft end of the single panel structure comprises a through connection; and

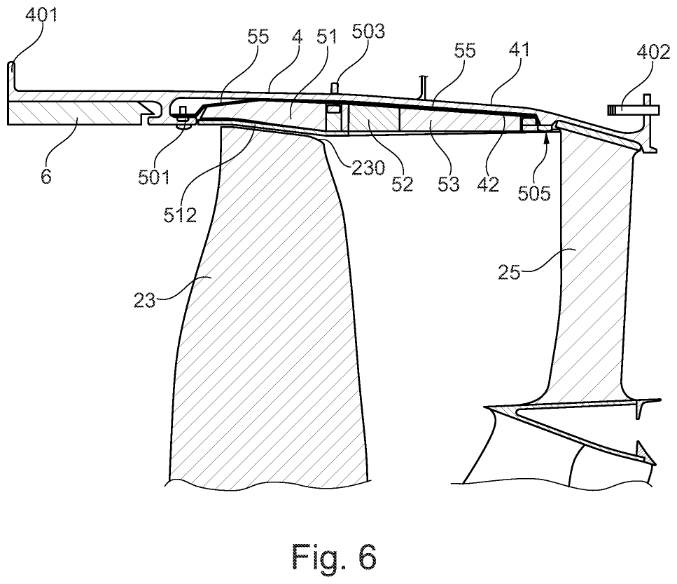

FIG. 6 is a still further embodiment of a fan case assembly comprising a fan track liner and a rear acoustic panel integrated into a single panel structure, wherein the aft end of the single panel structure forms a radial offset.

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclical gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclical gearbox 30 is a reduction gearbox.

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclical gear arrangement 30. Radially outwardly of the sun gear 28 and intermeshing therewith is a plurality of planet gears 32 that are coupled together by a planet carrier 34. The planet carrier 34 constrains the planet gears 32 to process around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

The epicyclical gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclical gearbox 30 generally comprise at least three planet gears 32.

The epicyclical gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclical gearbox 30 may be used. By way of further example, the epicyclical gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts. By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

In the context of this invention, the design of a fan case assembly enclosing the fan 23 is of relevance. It is pointed out that the fan case assembly that will be discussed in the following may be implemented in a geared turbofan engine as discussed with respect to FIGS. 1 to 3 but may generally be implemented in any gas turbine engine. The principles of the present invention are not dependent on a particular kind of gas turbine engine.

More particularly, a particularly useful application lies with Civil Small and Medium Engines. which may have a fan diameter in the range between 35 to 55″. The rotational speed of the fan of such Civil Small and Medium Engines may be in the range between 5000 and 9000 rpm at Maximum Takeoff Thrust.

FIG. 4 depicts a first embodiment of a fan case assembly for a gas turbine engine. The fan case assembly comprises a fan case 4 circumferentially surrounding a fan 23. The fan case 4 comprises a front end at which it is connected to an engine inlet (not shown), wherein the connection may be realized by means of a flange connection 401. The flange connection 401 is also referred to as an A1 connection. The fan case 4 further comprises an aft end at which it is connected to further structural elements of the gas turbine engine nacelle. The connection may be realized by means of a flange connection 402 which is also referred to as A3 connection.

The fan case 4 comprises an outer surface 41 and an inner surface of 42, wherein the inner surface 42 faces the flow path through the fan 3. Several panels are arranged along the inner surface 42. Upstream of the fan 3 is located a front acoustic panel 6 absorbing sound which, however, is of no particular concern in the present context. There is further provided a single panel structure 5 attached to the fan case 4 which includes a plurality of different compartments providing different structures and associated functions.

More particularly, the single panel structure 5 forms radially outward to the fan 23 and adjacent to the fan blade tips 230 a fan track liner compartment 51 which comprises a layer 512 of abradable material. The layer 512 of abradable material minimizes air leakage around the blade tips 230. The single panel structure 5 further forms an ice impact liner compartment 52 aft of the fan track liner compartment 51 and a rear acoustic panel compartment 53 aft of the ice impact liner compartment 52. The ice impact liner compartment 52 is configured to withstand ice shed from the fan rotor blades. The rear acoustic panel compartment 53 is configured to attenuate noise and improve flutter margin.

In addition, the fan track liner compartment 51 may be structurally embodied in such a manner that it is suited for receiving fan fragments in the event that a fan blade breaks and for avoiding that they penetrate the engine nacelle in an outward direction.

The single panel structure 5 further comprises an outer tray 55 which extends between a front end and an aft end of the single panel structure 5. The outer tray 55 represents an outer structure which serves to receive and hold the different compartments 51, 52, 53. The outer tray 55 is formed in a straight manner along most of its length. The outer tray 55 is connected at three axial positions to the fan case 4. The first axial position is a front position at which the outer tray 55 is connected to the fan case 4 by a row of fasteners 501 such as a row of screws. The second position is an aft position at which the outer tray 55 is connected to the fan case 4 by a second row of fasteners 502. The third position is a middle position at which the outer tray 55 is connected to the fan case 4 by a third row of fasteners 503.

The outer tray 55 may be formed as one piece. It may be formed by a glass fiber composite or from a carbon fiber composite material.

In the depicted embodiment, there are provided non-structural outlet guide vanes 25 at the beginning of the bypass channel of the gas turbine engine. Such outlet guide vanes 25 limit the length of the rear acoustic panel compartment 53.

The single panel structure 5 is depicted in FIG. 4 in a cross-sectional view. In the circumferential direction, the single panel structure 5 may consist of a plurality of panels each extending in the circumferential direction over less than 360°. In embodiments, the single panel structure 5 may consist of five to thirteen panel structures each extending 360°/(number of panel structures) in the circumferential direction.

The single panel structure 5 of FIG. 4 is depicted in enlarged view in FIG. 4A. With respect to attachment of the outer tray 55 to the fan case 4, FIG. 4A shows in more detail on that the inner skin of the single panel structure 5 and the outer tray 55 form at the front end of the single panel structure 5 a front flange 551 which is fastened by the row of screws 501 to the fan case 4. In a similar manner, the inner skin of the single panel structure 5 and the outer tray 55 form at the aft end of the single panel structure 5 an aft flange 552 which is fastened by the row of screws 502 to the fan case 4. By the outer tray 55 extending to the aft flange 552, particular stiffness for the unsupported span is provided for. Also, by avoiding through fasteners, there is a reduced fire and vent concern. A third row of fasteners such as bolts 503 provides for attachment of the outer tray 52 to the fan case 4 in a middle region.

The first, second and third compartments 51 to 53 of the single panel structure 5 which form the fan track liner, the ice impact panel and the rear acoustic panel each comprise a honeycomb core structure, wherein the honeycomb core structures of the different compartments 51 to 53 differ in at least one of cell configuration, cell size and density. Generally, the honeycomb core structure is part of a honeycomb sandwich structure additionally comprising an inner face sheet and an outer face sheet, wherein the outer face sheet may be formed by respective sections of the outer tray 55 or is a separate outer face sheet (not shown) attached to the inside of outer tray 55. For example, there may be a glass layer between the outer tray 55 carbon fiber and the honeycomb structure.

More particularly, the first compartment 51 which forms the fan track liner comprises a honeycomb core structure 510, an inner septum sheet 511 and the layer 512 of abradable material. The layer 512 of abradable material is attached to the inner septum sheet 511. The honeycomb core structure 510 may comprise a Flex-core cell configuration available from the company Hexcel Corporation.

The second compartment 52 which forms the ice impact panel comprises a honeycomb core structure 520 and an inner face sheet 521. The face sheet, in embodiments, is a non-perforated face sheet formed by a laminated material comprised of a plurality of plies. For example, the face sheet of 521 may comprise several plies of glass fiber composites and several plies of high modulus polypropylene composites. The total thickness of the face sheet 521 may be in the range between 1.5 and 4 millimeter. The honeycomb core structure 520 may comprise the typical hexagonal cell configuration but may be higher density and/or wall thickness relative to honeycomb core structure 510. Alternatively, the honeycomb core structure 520 and the aft portion of honeycomb core structure 510 may be of the same honeycomb core structure and density. Generally, the aft section of honeycomb core structure 510 may be denser than the front section of honeycomb cores structure 510, i.e., honeycomb core structure 510 could be divided into two sections. In such case, in embodiments, the front section has a density in the range between 4 and 6 pcf and the aft section has a density in the range between 7.5 and 12.5 pcf.

However, in other embodiments, the face sheet 521 may be a perforated face sheet which allows to the second compartment 52 to participate in noise reduction and flutter mitigation provided by the third compartment.

The third compartment 53 which forms the rear acoustic panel comprises a honeycomb core structure 530 and an inner face sheet 531. The face sheet 531 is a perforated face sheet which may be formed by a glass fiber composite. Alternatively, carbon fiber composites may be included to form the face sheet 531. The honeycomb core structure 530 may comprise the typical hexagonal cell configuration.

The cell configurations 510, 520, 530 of the three compartments 51, 52, 53 may differ to provide for the respective desired capability needs. For example, the honeycomb core structure 510 may have a higher density than the honeycomb core structure 530. The honeycomb core structure 520 of compartment 52 may have a greater cell depth than the honeycomb core structure 530 of compartment 53. This reflects that in the sections of the single panel structure 5 which form the ice impact panel compartment 52 and the rear acoustic panel department 53, the single panel structure 5 converges in cross-section in the aft direction.

FIG. 5 shows a further embodiment of a fan case assembly which differs from the embodiment of FIG. 4 only in the manner that the aft end of the single panel structure 5 is connected to the fan case 4. Accordingly, with respect to all other issues, reference is made to FIGS. 4, 4A.

In the embodiment of FIGS. 4, 4A the outer tray 55 is bent inward at the aft end to form an aft flange together with the inner skin of the rear acoustic panel compartment. The embodiment of FIG. 5 in comparison is easier to produce, wherein a through fastener 504 is used to connect the fan case 4, the outer tray 55 and the compartment 53. To this end, the structure of the rear acoustic panel compartment 53 is reinforced in the area of the through fastener. In an embodiment, this may include potting in the panel to provide compression strength to the honeycomb so a screw or bolt would not crush it. Also the outer tray 55 can be seen offset from the fan case inner surface 42 with a laid-up pad spacing it off at the bolt through location 504. This potting reduces the effective acoustic area, but is implemented at the panel's very end which typically comprises foaming film adhesive or similar to close out the aft edge such that there is already a reduction in effective area required for structural reasons.

FIG. 6 shows a still further embodiment of a fan case assembly which also differs from the embodiment of FIG. 4 only in the manner that the aft end of the single panel structure 5 is connected to the fan case 4. In the embodiment of FIG. 6, the rear acoustic panel compartment 53 forms a radial offset 506 which is captured by a retention block or segmented ring 505 which is fastened to the fan case. Axial fixation of the single panel structure 5 is provided for by front and middle fasteners 501 and 503. This embodiment is associated with a particularly simple manner of installation, wherein the retention block 505 only needs to be fastened into the case and not through the panel. Another benefit is to avoid a perforated firewall as well as enabling the thinnest case possible there.

The retention block or retention ring 505 may be a removable flange that is bolted to the aft end of compartment 53.

Another potential option which yields the same benefits is to have a screw through a small strap and then have a potted insert in the aft end of the compartment 53.

A general preference to enable the concept described with respect to FIGS. 4 to 6 is a generally converging profile of the fan case 4 between the front fasteners 501 and the outlet guide vanes 25. This supports the possibility that the outer tray 55 is one piece (even if a step for a radial offset from the case is needed over perforated areas).

It should be understood that the above description is intended for illustrative purposes only and is not intended to limit the scope of the present disclosure in any way. Also, those skilled in the art will appreciate that other aspects of the disclosure can be obtained from a study of the drawings, the disclosure and the appended claims. All methods described herein can be performed in any suitable order unless otherwise indicated herein or otherwise clearly contradicted by context. Various features of the various embodiments disclosed herein can be combined in different combinations to create new embodiments within the scope of the present disclosure. In particular, the disclosure extends to and includes all combinations and sub-combinations of one or more features described herein. Any ranges given herein include any and all specific values within the range and any and all sub-ranges within the given range.

1. A fan case assembly for a gas turbine engine, the fan case assembly comprising:
a fan case having an inner surface;
a fan track liner comprising an abradable material layer; and
a rear acoustic panel arranged aft of the fan track liner;
wherein the fan track liner and the rear acoustic panel are integrated into a single panel structure attached to the fan case inner surface.

2. The fan case assembly of claim 1, wherein the single panel structure comprises an outer tray extending between a front end and an aft end of the single panel structure, wherein the outer tray forms an outer structure of the single panel structure holding the fan track liner and the rear acoustic panel, wherein the outer tray is connected to the fan case.

3. The fan case assembly of claim 2, wherein the outer tray is connected at three axial positions only to the fan case.

4. The fan case assembly of claim 3, wherein the outer tray is connected to the fan case at a front end, at an aft end, and at a middle position.

5. The fan case assembly of claim 2, wherein the connection between the outer tray and the fan case is by means of fasteners, the fasteners comprising at least one of screws, bolts and flange connections.

6. The fan case assembly of claim 2, wherein the fan track liner and the rear acoustic panel are formed by two different compartments of the single panel structure.

7. The fan case assembly of claim 6, wherein the fan track liner compartment and the rear acoustic panel compartment each comprise a honeycomb core structure, wherein the honeycomb core structures of the fan track liner compartment and the rear acoustic panel compartment differ in at least one of cell configuration, cell size and density.

8. The fan case assembly of claim 7, wherein the honeycomb core structure of the fan track liner compartment comprises a Flex-Core cell configuration.

9. The fan case assembly of claim 7, wherein the honeycomb core structure of the rear acoustic panel compartment comprises a hexagonal cell configuration.

10. The fan case assembly of claim 7, wherein the honeycomb core structure of the fan track liner compartment has a higher density than the honeycomb core structure of the rear acoustic panel compartment.

11. The fan case assembly of claim 7, wherein the honeycomb core structure of the fan track liner compartment is covered by a septum inner sheet to which a layer of abradable material is attached.

12. The fan case assembly of claim 7, wherein the honeycomb core structure of the rear acoustic panel is covered by a perforated inner face sheet.

13. The fan case assembly of claim 6, wherein an inner skin of the rear acoustic panel compartment and the aft end of the outer tray together form an aft flange which is connected to the fan case.

14. The fan case assembly of claim 6, wherein an inner skin of the rear acoustic panel compartment and the aft end of the outer tray are connected to the fan case by means of a through fastener, wherein the structure of the rear acoustic panel is reinforced in the area of the through fastener.

15. The fan case assembly of claim 6, wherein an inner skin of the rear acoustic panel compartment forms a radial offset that is radially trapped with a retention ring that is bolted to the structure of the fan case.

16. The fan case assembly of claim 2, wherein the outer tray is a tray formed by carbon fiber composite material.

17. The fan case assembly of claim 7, wherein the single panel further comprises an ice impact liner compartment arranged between the fan track liner compartment and the rear acoustic panel compartment, wherein the ice impact liner compartment comprises a honeycomb core structure different from the honeycomb core structures of the fan track liner compartment and the rear acoustic panel compartment.

18. The fan case assembly of claim 17, wherein the ice impact liner compartment comprises a non-perforated inner face sheet formed by a laminate material comprised of a plurality of plies.

19. The fan case assembly of claim 1, wherein the single panel structure comprises an inner skin delimiting the outer flow path through the fan, wherein the inner skin comprises at least in sections a layer made of high modulus polypropylene fibers or hybrid fibers containing high modulus polypropylene.

20. The fan case assembly of claim 1, wherein at least the rear acoustic panel compartment of the single panel structure in cross section converges along its full length in the aft direction.
